(19) United States
(12) Patent Application Publication
(10) Pub. No.: US 2004/0107613 A1
(43) Pub. Date: Jun. 10, 2004

(54) Automatic blinder-type display assembly

(76) Inventor: Sun Eun Park, Daegu (KR)

Correspondence Address: FENWICK & WEST LLP, SILICON VALLEY CENTER, 801 CALIFORNIA STREET, MOUNTAIN VIEW, CA, 94041, US

(21) Appl. No.: 10/435,126

(22) Filed: May 9, 2003

(30) Foreign Application Priority Data
Dec. 6, 2002 (KR) 2002-0077295

(51) Int. Cl. G09F 11/18

(52) U.S. Cl. 40/515

(57) ABSTRACT

Disclosed is a blinder-type display assembly capable of being installed anywhere, such as residences, offices or recreational areas for the purpose of decoration, exhibition or advertisement, and if necessary, for selectively displaying an exhibition. The display assembly comprises a bi-directional motor having a rotating shaft with one end chamfered, a horizontal cylindrical hollow frame member accommodating the motor and being rotatable by rotation of the motor, a flexible flat exhibition sheet secured to a lower portion of the horizontal frame member and wound on the frame member or deployed from the frame member by the rotation of the motor, an equilibrium weight secured to a lowermost portion of the exhibition sheet, and a control unit for controlling the rotation of the motor. The horizontal cylindrical frame member is provided at one end with a cap member secured to the motor, the cap member having a hole through which the chamfered end of the rotating shaft of the motor is fitted.

### BACKGROUND OF THE INVENTION

1. Field of the Invention

The present invention relates to a blinder-type display assembly, and more particularly, to a blinder-type display assembly capable of being installed anywhere, such as residences, offices and recreational areas for the purpose of decoration, exhibition or advertisement, and if necessary, for selectively displaying an exhibition.

2. Description of the Related Art

In general, an exhibition comprising a picture and advertisement is displayed so that it is accommodated in a frame for the purpose of decoration, exhibition or protection. Since the exhibition accommodated in the frame is displayed at a fixed location for a long period of time, a person may grow tired of the stationary exhibition with the passage of time. In order to change the atmosphere, it may be necessary to remove the exhibition or replace it with a new exhibition.

Since it is not easy to replace the used framed exhibition with a new exhibition, a new framed exhibition is often purchased. In order not to display the exhibition, there may be problems in that the framed exhibition is removed from the exhibition space. In addition, since the framed exhibition may be installed only on a wall, installing space may be limited.

### SUMMARY OF THE INVENTION

The present invention is directed to an automatic blinder-type display assembly that substantially obviates one or more problems due to limitations and disadvantages of the related art.

It is an object of the present invention to provide an automatic blinder-type display assembly capable of being installed on a wall or window of a residences, offices or recreational areas in which the exhibit is automatically displayed and retracted, thereby maximizing the exhibition effect.

Another object of the present invention is to provide an automatic blinder-type display assembly capable of selectively displaying a plurality of exhibitions, thereby maximizing the exhibition effect.

To achieve these objects and other advantages in accordance with the purpose of the invention, as embodied and broadly described herein, there is provided an automatic blinder-type display assembly capable of automatically displaying and retracting an exhibition, the display assembly comprising: a bi-directional motor having a rotating shaft with one end chamfered; a horizontal cylindrical hollow frame member fixedly accommodating the motor and being rotatable by rotation of the motor; a flexible flat exhibition sheet secured to a lower portion of the horizontal frame member and wound on the frame member or deployed from the frame member by the rotation of the motor; an equilibrium weight secured to a lowermost portion of the exhibition sheet; and a control unit for controlling the rotation of the motor. The horizontal cylindrical frame member is provided at one end with a cap member secured to the motor, the cap member having a hole through which the chamfered end of the rotating shaft of the motor is fitted.

The display assembly further comprises frame means enclosing the display assembly in a flat rectangular shape, and an exhibition back plate disposed at a back side of the exhibition sheet. The horizontal frame member is secured to the upper portion of the frame means, and a transparent display window is disposed in the frame members at a front side of the exhibition sheet.

The display assembly further comprises a frame shielding member for shielding a framework of the exhibition sheet between the exhibition sheet and the transparent display window.

A transparent display window is disposed between the exhibition back plate and the exhibition sheet.

The display assembly further comprises a lighting lamp, and the control unit is operated by an electrical frequency, and includes a central processing unit connected to a power source, a motor and a receiver, and a remote controller for transferring a control signal of the power source, motor or lighting lamp to the receiver. The control signal of the remote controller is transferred to the central processing unit through the receiver, and the power source, the motor and the lighting lamp are operated by an operating control of the central processing unit.

The display assembly further comprises a lighting lamp, and the control unit is operated by a sound signal, and includes a central processing unit connected to a power source, a motor and a receiver. The control signal of the sound signal is transferred to the central processing unit through the receiver, and the power source, the motor and the lighting lamp are operated by an operating control of the central processing unit.

The power source is any one of a battery and a power supply having 12 DC volts.

A bearing is installed in a portion of the frame means, in which the cylindrical frame member is disposed, such that the cylindrical frame member is idly rotated.

An end of the cylindrical frame member is formed at an outer periphery with a downward protruded portion for securing the motor, and a motor fixing plate is secured in one end of the motor, and has a groove formed at an outer periphery for receiving the downward protruded portion, so that the motor is secured by the downwardly protruded portion of the frame member, wherein the cap member secured to one end of the frame member has a groove formed at a position corresponding to the downward protruded portion of the frame member and the groove of the fixing plate.

The cylindrical frame member is provided at the other end with a bearing so as to prevent wiring of the motor from being entangled.

According to another aspect of the present invention, there is provided an automatic blinder-type display assembly capable of automatically displaying and retracting an exhibition, the display assembly comprising: a multiple display blinder having a bi-directional motor with at least one driving pulley coupled in series to a rotating shaft; frame means enclosing the multiple display blinder in a flat rectangular shape; transparent display windows each disposed at front and back sides of the frame means; and a control unit for controlling rotation of the motor. The multiple display blinder includes a horizontal frame member, in which a motor is accommodated, a plurality of exhibition plates, each connected pivotably and movably up and down to the frame member, a guide for guiding vertical movement of the plurality of exhibition plates, with one end secured to the frame member and the other end secured to the frame means opposite to the frame member through the plurality of exhibition plates, and a guide wire for guiding pivotal movement of the plurality of exhibition plates, with one end secured to the driving pulley of the motor and the other end secured to edges of the exhibition plates.

According to a further aspect of the present invention, there is provided an automatic blinder-type display assembly capable of automatically displaying and retracting an exhibition, the display assembly comprisinge: a foldable display blinder having a bi-directional motor with at least one driving pulley coupled in series to a rotating shaft, frame means enclosing the foldable display blinder in a flat rectangular shape; transparent display windows each disposed at front and back sides of the frame means; and a control unit for controlling rotation of the motor. The foldable blinder includes a horizontal frame member in which the motor is accommodated, a foldable corrugated exhibition sheet with an upper end coupled to a lower portion of the frame member, an equilibrium weight secured to the lowermost end of the exhibition sheet, and a guide wire with one end secured to the driving pulley of the motor and the other end secured to the equilibrium weight.

The exhibition may comprise a picture and an advertisement.

The exhibition sheet consists of a fiber, a fabric or a non-woven fabric.

The exhibition sheet is used to display the exhibition, shield light, secure privacy, or isolate heat by interrupting the inflow or outflow of air.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing the structure of an automatic blinder-type display assembly according to one preferred embodiment of the present invention;

FIG. 2 is a block diagram of a control unit for controlling the operation of a power source, a motor and a lighting lamp by use of a remote controller;

FIG. 3 is an exploded perspective view of the display assembly shown in FIG. 1;

FIG. 4 is an exploded perspective view of a roll type blinder shown in FIG. 3;

FIG. 5 is an exploded perspective view of a display assembly employing a blinder according to another embodiment of the present invention;

FIG. 6 is a view showing the structure of a display assembly according to another preferred embodiment of the present invention; and

FIG. 7 is a view similar to the embodiments shown in FIGS. 5 and 6, and shows the structure of a display assembly employing the roll blinder of FIG. 4.

### DETAILED DESCRIPTION OF THE PREFERRED EMBODIMENT

Reference will now be made in detail to the preferred embodiment of the present invention, an example of which is illustrated in the accompanying drawings.

A motor used in the present invention is a bi-directional motor, and an exhibition generally means a displaying device comprising a picture or an advertisement. The picture or advertisement itself may be directly printed on a sheet, or may be utilized in the form of a printed sheet.

Despite description with reference to several embodiments of the present inventions, the means for displaying the exhibition includes one sheet or a plurality of plates. This means is independently utilized as a display assembly, or may be utilized in a framed case so as to provide decorative effect and protection of the exhibition.

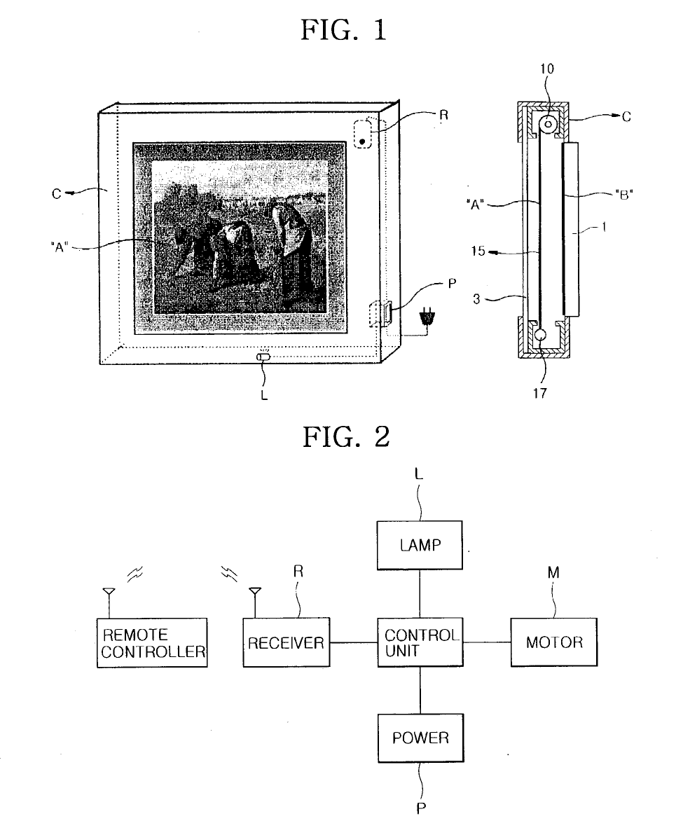

FIG. 1 is a view showing the structure of an automatic blinder-type display assembly according to one preferred embodiment of the present invention.

A blinder employed in FIG. 1 is a roll blinder 10 including a horizontal cylindrical frame member accommodating a motor and rotated by the rotation of the motor, an exhibition sheet 15 secured to a lower side of the horizontal frame member, and an equilibrium weight 17 secured to the lowermost portion of the exhibition sheet to provide the exhibition sheet with a dead load. The exhibition sheet 15 is printed or attached with a picture or advertisement A. The exhibition sheet may be retrieved or displayed in such a manner that the exhibition sheet is rolled or unrolled from the horizontal frame member due to the rotation of the horizontal frame member by the motor.

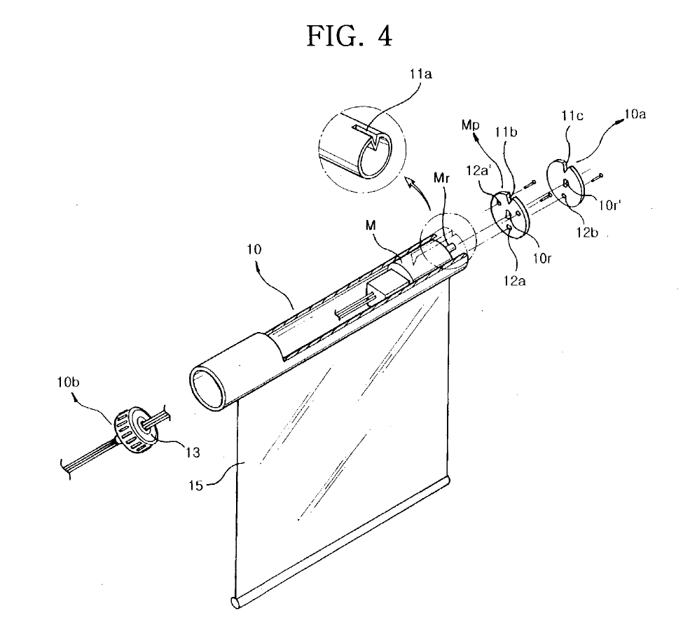

Since the horizontal frame member of the roll blinder 10 has a structure that the frame member itself is rotated by the rotation of the motor, the exhibition sheet secured to the lower portion of the frame member is deployed or wound on the frame member by the rotation of the motor so as to display or retract the exhibition. Accordingly, the roll blinder may independently display the exhibition, which will be described with reference to FIG. 4.

In order to provide the decorative effect and protection of the exhibition, the roll blinder 10 may be equipped with a rectangular frame means C along a periphery of the roll blinder 10. The frame means has a rectangular frame capable of accommodating the deployed roll blinder in its entirety. The frame means is provided with a transparent display window 3 and a back plate 1 at front and back sides of the exhibition sheet 15, respectively.

The front surface of the back plate 1 is printed or attached with a background picture or advertisement B. If the exhibition sheet is retracted by operating the roll blinder accommodated in the frame means, the front surface of the back plate 1 is open to view through the transparent display window, so that the back ground picture or advertisement printed or attached to the front surface of the back plate is displayed.

The operation of the roll blinder may be carried out by a remote controller or a sound signal. At that time, the signal of the remote controller or the external sound signal is transferred to the display assembly through a receiver R installed to the frame means C. The display assembly includes a receiver R for receiving the external signal, a motor M for deploying or retracting the exhibition, a lighting lamp L for illuminating the exhibition, a power source P, and a central processing unit connected to the above parts. If the central processing unit receives the signal of the remote controller or the sound signal through the receiver, the operation of the power source, motor and lighting lamp is controlled by means of a control signal outputted from the central processing unit. At that time, the power source may be any one of a built-in battery and a power supply having 12 DC volts. The structure of the central processing unit is shown in FIG. 2.

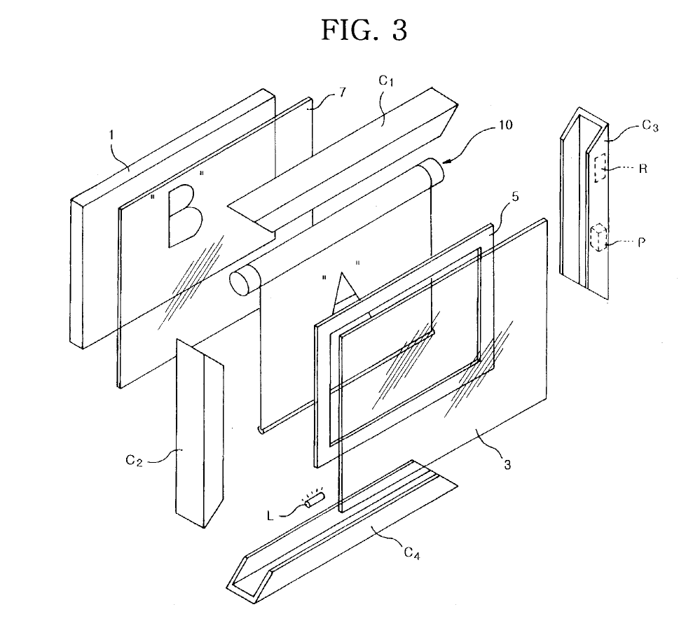

FIG. 3 is an exploded perspective view of the display assembly shown in FIG. 1. As described above, the display assembly is adapted to enclose the roll blinder with the frame means.

The frame means enclosing the roll blinder 10 includes an upper frame C1 enclosing the horizontal cylindrical frame member of the roll blinder, a pair of vertical frames C2 and C3 disposed downward from both ends of the upper frame, and a lower frame C4 disposed between the vertical frames. The rectangular frame means accommodating the roll blinder 10 may be formed by assembling the above frames. Since the roll blinder 10 is rotated by the rotation of the motor, a bearing (not shown) is installed into a portion of the upper frame C1 in which the horizontal frame member of the roll blinder is disposed.

The back plate 1 is disposed at the back side of the frame means, and the background exhibition, such as the picture or advertisement B, is attached to the front surface of the back plate. The front transparent display window 3 made of glass is disposed at the front side of the roll blinder 10 in the frame means. Alternatively, a back transparent display window 7 may be disposed between the roll blinder and back plate. Furthermore, a frame shielding member 5 may be installed between the roll blinder 10 and the front display window to shield the framework of the picture or advertisement A.

The frame means accommodates the power source P for supplying the power to the lighting lamp L illuminating the exhibition, and the receiver R for receiving the control signal from the remote controller to operate the motor or the lighting lamp.

If the exhibition sheet is deployed from the horizontal cylindrical frame member by the operation of the roll blinder, the picture or advertisement A of the exhibition sheet is displayed. If the exhibition sheet is wound on the horizontal frame member, the back plate 1 is open to view through the display window, so that the background picture or advertisement B is shown.

The above-mentioned display assembly may employ various kinds of blinders displaying the exhibition as several embodiments, and other elements except for the blinder may be identically constructed as described above.

FIG. 4 is an exploded perspective view of the roll blinder in FIG. 3.

The roll blinder 10 includes a horizontal hollow cylindrical frame member accommodating the motor M, an exhibition sheet 15 secured to the lower side of the horizontal frame member and printed or attached with the exhibition, and an equilibrium weight (not shown) secured to the lower end of the exhibition sheet to provide the exhibition sheet with a dead load.

The cylindrical frame member includes a hollow cylindrical frame body accommodating the motor, and first and second cap members 10a and 10b assembled to both ends of the body.

The motor includes a rotating shaft Mr having a chamfered end, and is disposed in one end of the cylindrical frame body. The end of the cylindrical frame body is formed at the outer periphery with a downward protruded portion 11a for securing the motor. A motor fixing plate Mp is secured in the one end of the motor, and has a groove 11b formed at an outer periphery for receiving the downward protruded portion 11a, so that the motor is secured by the downward protruded portion of the frame body.

The motor fixing plate Mp includes a circular hole 10r through which the rotating shaft passes, one fixing hole 12a′ for fixing the motor fixing plate to the motor by means of a screw, and the other fixing hole 12a for fixing the first cap member 10a to the motor by means of a screw.

The first cap member 10a is coupled to the end of the cylindrical frame body in which the motor is disposed, and then is fixed to the motor. The first cap member 10a has a groove 11c formed at a position corresponding to the downward protruded portion 11a of the frame body and the groove 11b of the fixing plate Mp. In addition, the first cap member 10a has a chamfered hole 10r′ through which the chamfered end of the rotating shaft Mr passes, and a fixing hole 12b for fixing the first cap member 10a to the motor by means of a screw.

Accordingly, in the state that the motor is fixed to the cylindrical frame body by the motor fixing plate Mp, during operation of the motor, the first cap member 10a engaged to the rotating shaft is rotated. Since the first cap member is secured to the motor and the cylindrical frame body, the cylindrical body itself is rotated with the motor by the rotation of the cap member. This rotation causes the exhibition sheet secured to the lower portion of the frame body to deploy or wind, thereby displaying or retracting the exhibition.

The cylindrical body is provided at the other end with a second cap member 10b with a bearing 13 installed so as to prevent the wiring of the motor from being entangled due to the rotation of the cylindrical frame body and the motor.

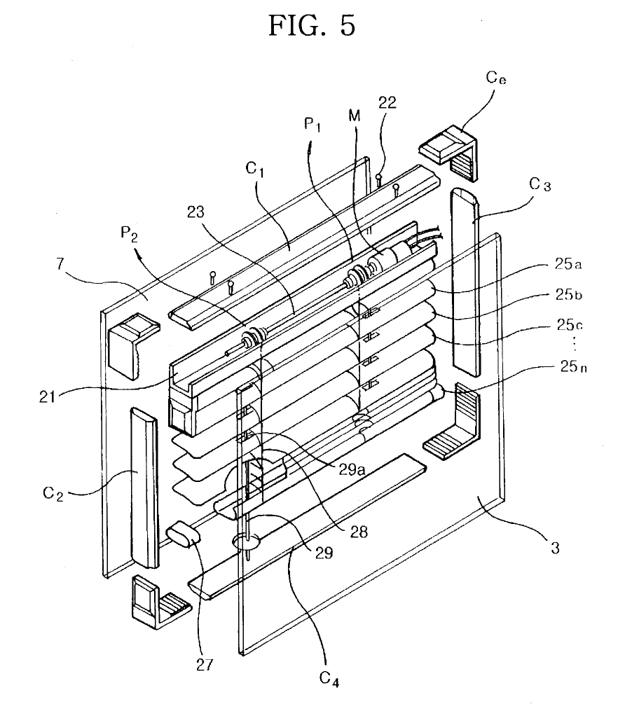

FIG. 5 is an exploded perspective view of a display assembly employing a multiple blinder according to another preferred embodiment of the present invention.

As shown in FIG. 5, the automatic blinder-type display assembly capable of automatically carrying out the display and retraction of the exhibition includes a multiple display blinder having a bi-directional motor M with at least one driving pulleys P1 and P2 coupled in series to a rotating shaft, frame means C1, C2, C3 and C4, transparent display windows 3 and 7 each disposed at front and back sides of the frame means, and a control unit for controlling the rotation of the motor.

The multiple display blinder includes a horizontal frame member 21 with a motor accommodated, a plurality of exhibition plates 25a, 25b, 25c, . . . , 25n each connected pivotably and movably up and down to the frame member, a guide 29 for guiding the vertical movement of a plurality of exhibition plates, with one end secured to the frame member and the other end secured to the frame means opposite to the frame member through the plurality of exhibition plates, and a guide wire 28 for guiding the pivotal movement of the plurality of exhibition plates, with one end secured to the driving pulley of the motor and the other end secured to edges of the exhibition plates.

The plurality of exhibition plates are hung by means of the guide wire with one end secured to the driving pulley in which the exhibition plates are moved up and down by the guide wire to display or retract the exhibition. At the uppermost position, the plurality of exhibition plates are laid in parallel to each other, with flat portions thereof being oriented upward. The exhibition plates are moved downward by the rotation of the motor, and simultaneously are pivotally rotated such that the flat portion orients the front of the display assembly. If the exhibition plates reach the lowermost position, the exhibition printed or attached to the respective plates is open to view in a perfect state.

When the exhibition plates move up and down by rotation of the motor, the rotating speed of the motor may be adjusted by means of a speed reducer (not shown) disposed adjacent to the motor.

The lowermost exhibition plate 25n may be provided at both ends with an equilibrium weight 27 to provide the exhibition sheet with a load and a decorative effect.

The guide wire 28 guides the pivotal movement of the plurality of exhibition plates, with one end secured to the driving pulleys P1 and P2 of the motor and the other end secured to the edges of the last exhibition plates through sides of the center portions 29a of the exhibition plates.

The frame means includes an upper frame C1, vertical frames C2 and C3 each disposed under both sides of the upper frame, and a lower frame C4 opposed to the upper frame and disposed between ends of the vertical frame. A bracket Ce may be installed at the corner of the respective frames.

The upper frame C1 covers the upper surface of the horizontal frame member 21, and is secured to the frame member by means of a fastening member 22 such as a screw, the upper surface being opened to accommodate the motor.

The frame member is provided at front and back sides with transparent display windows 3 and 7, thereby protecting the exhibition and improving the decorative effect.

According to another embodiment of the present invention, the display assembly employs a foldable blinder, instead of the above-mentioned multiple blinder.

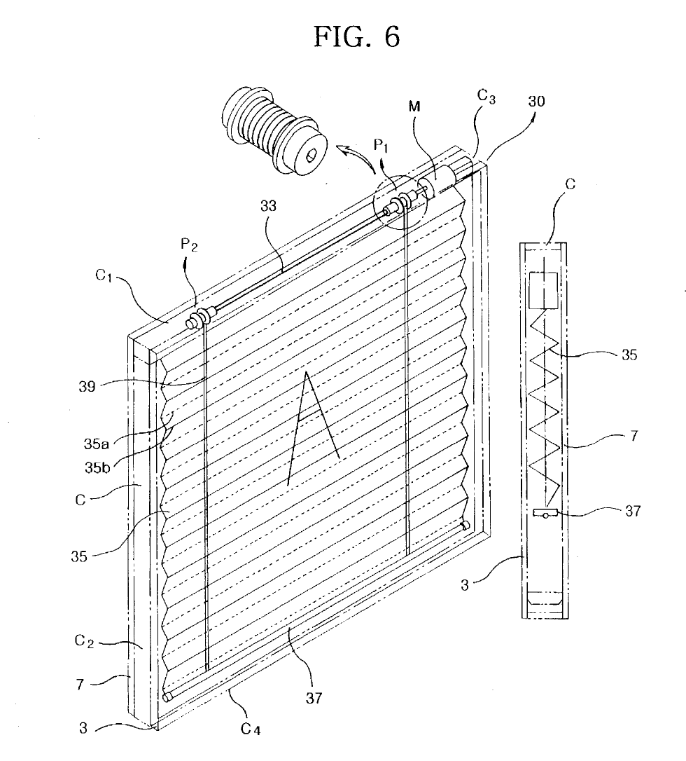

FIG. 6 shows the display assembly employing the foldable blinder.

The foldable blinder 30 includes a bi-directional motor M with at least one of the driving pulleys P1 and P2 coupled in series to a rotating shaft 33, a horizontal frame member with the motor accommodated, a foldable corrugated exhibition sheet 35 with an upper end coupled to the lower portion of the frame member, an equilibrium weight 37 secured to the lowermost end of the exhibition sheet, and a guide wire 39 with one end secured to the driving pulley of the motor and the other end secured to the equilibrium weight.

The corrugated exhibition sheet consists of many pairs of corrugated portions 35a and 35b, each of the corrugated portions bent in a direction opposite to each other.

The foldable blinder 30 is accommodated in a space consisting of rectangular flat frames C1, C2, C3 and C4 (shown by an imaginary line) and transparent display windows 3 and 7 disposed at front and back sides of the frames, thereby improving the decorative and protective effect.

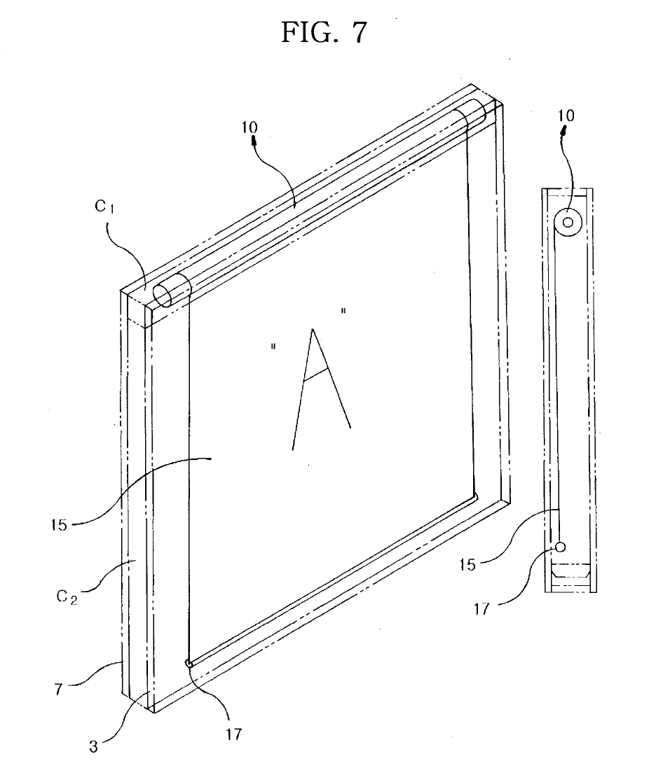

FIG. 7 shows another embodiment employing the roll blinder shown in FIG. 4, which is similar to the embodiments of the FIGS. 5 and 6.

A cylindrical frame member 10 with a motor accommodated is placed on an upper frame C1, such that an exhibition sheet 17 may be displayed or retracted by the rotation of the motor.

Structure and operation of the roll blinder are similar to those of the embodiment shown in FIG. 4, and structure of the frames and the transparent display windows enclosing the roll blinder is shown in the embodiments of FIGS. 5 and 6.

The control unit for the display assembly of the embodiments shown in FIGS. 5 to 7 may be operated by means of an electrical frequency or sound signal, similar to the control unit for the display assembly shown in FIG. 1, and includes a central processing unit connected to a power source, a motor and a receiver, and a remote controller for transferring a control signal of the power source and motor to the receiver. The control signal of the remote controller is transferred to the central processing unit through the receiver, and the power source and the motor are operated by means of an operating control of the central processing unit.

The display assembles of the above-mentioned embodiments may be installed everywhere, such as a wall, a window and so forth. If they are installed in a window, there are additional beneficial effects such as protection of privacy and isolation of heat, in addition to the decorative effect. If the exhibition is not applied to the exhibition sheet, the exhibition sheet may be utilized as a projector screen.

In light of the above description, the present invention may be installed in a wall or a window of anywhere such as a residences, offices or recreational areas. A plurality of exhibitions may be selectively displayed, and the display and retraction of the exhibition may be automatically performed.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An automatic blinder-type display assembly capable of automatically displaying and retracting an exhibition, the display assembly comprising:
a bi-directional motor having a rotating shaft with one end chamfered;
a horizontal cylindrical hollow frame member accommodating the motor and being rotatable by rotation of the motor;
a flexible flat exhibition sheet secured to a lower portion of the horizontal frame member and wound on the frame member or deployed from the frame member by the rotation of the motor;
an equilibrium weight secured to a lowermost portion of the exhibition sheet; and
a control unit for controlling the rotation of the motor,
wherein the horizontal cylindrical frame member is provided at one end with a cap member secured to the motor, the cap member having a hole through which the chamfered end of the rotating shaft of the motor is fitted.

2. The display assembly as claimed in claim 1, further comprising frame means enclosing the display assembly in a flat rectangular shape, and an exhibition back plate disposed at a back side of the exhibition sheet, wherein a transparent display window is disposed in the frame means at the front side of the exhibition sheet.

3. The display assembly as claimed in claim 2, further comprising a frame shielding member for shielding a framework of the exhibition sheet between the exhibition sheet and the transparent display window.

4. The display assembly as claimed in claim 2 or 3, wherein a transparent display window is disposed between the exhibition back plate and the exhibition sheet.

5. The display assembly as claimed in claim 1 or 2, further comprising a lighting lamp, wherein the control unit is operated by an electrical frequency, and includes a central processing unit connected to a power source, a motor and a receiver, and a remote controller for transferring a control signal of the power source, motor or lighting lamp to the receiver, and wherein the control signal of the remote controller is transferred to the central processing unit through the receiver, and the power source, the motor and the lighting lamp are operated by an operating control of the central processing unit.

6. The display assembly as claimed in claim 5, wherein the power source is any one of a battery and a power supply having 12 DC volts.

7. The display assembly as claimed in claim 1 or 2, further comprising a lighting lamp, wherein the control unit is operated by a sound signal, and includes a central processing unit connected to a power source, a motor and a receiver, and wherein the control signal of the sound signal is transferred to the central processing unit through the receiver, and the power source, the motor or the lighting lamp are operated by an operating control of the central processing unit.

8. The display assembly as claimed in claim 7, wherein the power source is any one of a battery and a power supply having 12 DC volts.

9. The display assembly as claimed in claim 2, wherein a bearing is installed in a portion of the frame means, in which the cylindrical frame member is disposed, such that the cylindrical frame member is idly rotated.

10. The display assembly as claimed in claim 1 or 2, wherein an end of the cylindrical frame member is formed at an outer periphery with a downward protruded portion for securing the motor, and a motor fixing plate is secured to one end of the motor, and has a groove formed at an outer periphery for receiving the downward protruded portion, so that the motor is secured by the downward protruded portion of the frame member, and wherein the cap member has a groove formed at a position corresponding to the downward protruded portion of the frame member and the groove of the fixing plate.

11. The display assembly as claimed in claim 1 or 2, wherein the cylindrical frame member is provided at the other end with a bearing so as to prevent wiring of the motor from being entangled.

12. The display assembly as claimed in claim 1 or 2, wherein the exhibition comprises a picture and an advertisement.

13. The display assembly as claimed in claim 1 or 2, wherein the exhibition sheet consists of a fiber, a fabric or a non-woven fabric.

14. The display assembly as claimed in claim 1 or 2, wherein the exhibition sheet is used to display the exhibition, shield light, protect privacy, or isolate heat by interrupting inflow or outflow of air.

15. An automatic blinder-type display assembly capable of automatically displaying and retracting an exhibition, the display assembly comprising:
a multiple display blinder having a bi-directional motor with at least one driving pulley coupled in series to a rotating shaft;
frame means enclosing the multiple display blinder in a flat rectangular shape;
transparent display windows each disposed at front and back sides of the frame means; and
a control unit for controlling rotation of the motor,
wherein the multiple display blinder includes a horizontal frame member with a motor accommodated, a plurality of display plates each connected pivotably and movably up and down to the frame member, a guide for guiding vertical movement of a plurality of display plates, with one end secured to the frame member and the other end secured to the frame means opposite to the frame member through the plurality of display plates, and a guide wire for guiding pivotal movement of the plurality of display plates, with one end secured to the driving pulley of the motor and the other end secured to edges of the display plates.

16. The display assembly as claimed in claim 15, wherein the control unit is operated by an electrical frequency, and includes a central processing unit connected to a power source, a motor and a receiver, and a remote controller for transferring a control signal of the power source and motor to the receiver, and wherein the control signal of the remote controller is transferred to the central processing unit through the receiver, and the power source and the motor are operated by an operating control of the central processing unit.

17. The display assembly as claimed in claim 15, wherein the control unit is operated by a sound signal, and includes a central processing unit connected to a power source, a motor and a receiver, and wherein the control signal of the sound signal is transferred to the central processing unit through the receiver, and the power source and the motor are operated by an operating control of the central processing unit.

18. The display assembly as claimed in claims 16 or 17, wherein the power source is any one of a battery and a power supply having 12 DC volts.

19. The display assembly as claimed in claim 15, wherein the exhibition comprises a picture and an advertisement.

20. The display assembly as claimed in claim 15, wherein the exhibition sheet is used to display the exhibition, shield light, protect privacy, or isolate heat by interrupting inflow or outflow of air.

21. An automatic blinder-type display assembly capable of automatically displaying and retracting an exhibition, the display assembly comprising:
a foldable display blinder having a bi-directional motor with at least one driving pulley coupled in series to a rotating shaft;
frame means enclosing the foldable display blinder in a flat rectangular shape;
transparent display windows each disposed at front and back sides of the frame means; and
a control unit for controlling rotation of the motor,
wherein the foldable blinder includes a horizontal frame member with the motor accommodated, a foldable corrugated exhibition sheet with an upper end coupled to a lower portion of the frame member, an equilibrium weight secured to the lowermost end of the exhibition sheet, and a guide wire with one end secured to the driving pulley of the motor and the other end secured to the equilibrium weight.

22. The display assembly as claimed in claim 21, wherein the control unit is operated by an electrical frequency, and includes a central processing unit connected to a power source, a motor and a receiver, and a remote controller for transferring a control signal of the power source and motor to the receiver, and wherein the control signal of the remote controller is transferred to the central processing unit through the receiver, and the power source and the motor are operated by an operating control of the central processing unit.

23. The display assembly as claimed in claim 21, wherein the control unit is operated by a sound signal, and includes a central processing unit connected to a power source, a motor and a receiver, and wherein the control signal of the sound signal is transferred to the central processing unit through the receiver, and the power source and the motor are operated by an operating control of the central processing unit.

24. The display assembly as claimed in claims 22 or 23, wherein the power source is any one of a battery and a power supply having 12 DC volts.

25. The display assembly as claimed in claim 21, wherein the exhibition comprises a picture and an advertisement.

26. The display assembly as claimed in claim 21, wherein the exhibition sheet consists of a fiber, a fabric or a non-woven fabric.

27. The display assembly as claimed in claim 21, wherein the exhibition sheet is used to display the exhibition, shield light, protect privacy, or isolate heat by interrupting inflow or outflow of air.

28. The display assembly as claimed in claim 1, further comprising frame means enclosing the display assembly in a flat rectangular shape such that the horizontal cylindrical frame member of the display assembly is secured to an upper portion of the frame means, and transparent display windows each disposed at front and back sides of the frame members.
